(19) United States
(12) Patent Application Publication
(10) Pub. No.: US 2021/0156445 A1
(43) Pub. Date: May 27, 2021

(54) CORRUGATED HOLLOW STRUCTURES AND TWO-STEP MOLDING OF CORRUGATED HOLLOW STRUCTURES

(71) Applicant: GM GLOBAL TECHNOLOGY OPERATIONS LLC, Detroit, MI (US)

(72) Inventors: Bradley A. NEWCOMB, Troy, MI (US); Selina X. ZHAO, Rochester Hills, MI (US); Thomas PALMER, Royal Oak, MI (US)

(73) Assignee: GM GLOBAL TECHNOLOGY OPERATIONS LLC, Detroit, MI (US)

(21) Appl. No.: 16/695,855

(22) Filed: Nov. 26, 2019

(51) Int. Cl. F16F 7/00; B29B 11/06; B29C 65/02; B29C 65/00; F16F 7/12

(52) U.S. Cl. CPC F16F 7/003; B29B 11/06; B29C 65/02; B29L 2031/30; B29C 66/721; F16F 7/12; B29K 2995/0091; B29C 66/73941

(57) ABSTRACT

A method of manufacturing an energy-absorbing structure according to various aspects of the present disclosure via a two-step molding process includes molding first and second portion precursors including thermoset polymers (e.g., thermoset polymer composites) to a first degree of cure (DOC) less than one so that the portion precursors are in a gelled glass state. The method further includes joining the first and second portion precursors by applying heat and pressure in a joining region such that the thermoset polymers have a second DOC greater than the first DOC and are cross-linked in the joining region. The energy-absorbing component therefore has a unitary structure. The method may further include coupling the energy-absorbing structure to a housing. In certain aspects, energy-absorbing structures may have tailored stiffness and/or tailored crush initiation.

### INTRODUCTION

This section provides background information related to the present disclosure which is not necessarily prior art.

The present disclosure relates to corrugated hollow structures, such as energy-absorbing components, and methods of manufacturing corrugated hollow structures via two-step molding.

It is advantageous to improve crush performance of vehicle components. However, it is also advantageous that components of automobiles or other vehicles be lightweight to improve fuel efficiency. Thus, vehicle components that exhibit both adequate strength during normal service and energy-absorption characteristics under extraordinary conditions such as collisions, while minimizing component weight are advantageous.

### SUMMARY

This section provides a general summary of the disclosure, and is not a comprehensive disclosure of its full scope or all of its features.

In various aspects, the present disclosure provides a method of manufacturing an energy-absorbing structure. The method includes molding a first portion precursor. The first portion precursor includes a first thermoset resin. Molding includes partially curing the first thermoset resin such that the first thermoset resin has a first degree of cure less than one and the first thermoset resin is in a gelled glass state. The first portion precursor includes a pair of first flange portions and first wall portion disposed between the pair of first flange portions. The method further includes molding a second portion precursor. The second portion precursor includes a second thermoset resin. The molding includes partially curing the second thermoset resin such that the second thermoset resin has a second degree of cure less than one and the second thermoset resin is in the gelled glass state. The second portion precursor includes a pair of second flange portions and a second wall portion disposed between pair of second flange portions. The method further includes forming the energy-absorbing structure. The forming includes arranging the first portion precursor and the second portion precursor in a mold such that the pair of first flanges portions is in contact with the pair of second flange portions in a respective pair of joining regions. The forming further includes joining the first portion precursor and the second portion precursor by applying heat and pressure to the pair of joining regions such that the first thermoset resin has a third degree of cure and the second thermoset resin has a fourth degree of cure. The third degree of cure being greater than the first degree of cure and the fourth degree of cure being greater than the second degree of cure. The energy-absorbing structure includes a pair of flanges and a cell. The pair of flanges is disposed in the pair of joining regions, respectively. The cell includes a cell wall and an interior region at least partially defined by the cell wall. The cell wall includes the first wall portion and the second wall portion.

In one aspect, the arranging includes directly contacting the pair of first flange portions with the pair of second flange portions in the respective joining regions. The joining further includes cross-linking the first thermoset resin and the second thermoset resin in the joining regions.

In one aspect, the forming further includes placing a mandrel between the first wall portion and the second wall portion prior to the joining.

In one aspect, the arranging further includes placing a third portion precursor between the first portion precursor and the second portion precursor such that the third portion precursor is in direct contact with the pair of first flange portions and the pair of second flange portions in the respective joining regions. The third portion precursor includes a third thermoset resin. The joining further includes cross-linking the third thermoset resin with the first thermoset resin and the second thermoset resin in the respective joining regions.

In one aspect, the method further includes molding the third portion precursor prior to the forming. The third portion precursor includes a third thermoset resin. The molding includes partially curing the third thermoset resin such that the third thermoset resin has a fifth degree of cure less than one. The joining causes the third thermoset resin to have a sixth degree of cure greater than the fifth degree of cure.

In one aspect, the third portion precursor includes a third thermoset resin. Prior to the forming, the third portion precursor has a predetermined viscosity and a fifth degree of cure, the fifth degree of cure being about zero. The joining causes the third thermoset resin to have a sixth degree of cure greater than the fifth degree of cure.

In one aspect, the third portion precursor includes a third plurality of reinforcing fibers. At least a portion of the third plurality of reinforcing fibers is oriented substantially parallel to a thickness of the flange.

In one aspect, the third portion precursor includes an average roughness of greater than or equal to about 0.1 μm, a surface texture, a plurality of ribs, or any combination thereof.

In one aspect, the flanges each have a width of greater than or equal to about 10 mm. The width is defined between the cell wall and a respective distal flange end.

In one aspect, the molding the first portion precursor includes determining that the first thermoset resin has the first degree of cure based on output from a first dielectric cure sensor. The molding the second portion precursor includes determining that the second thermoset resin has the second degree of cure based on output from a second dielectric cure sensor. The joining includes determining that the first thermoset resin has the third degree of cure and the second thermoset resin has the fourth degree of cure based on output from a third dielectric cure sensor.

In one aspect, the method further includes forming a weep opening in the cell wall.

In various aspects, the present disclosure provides an energy-absorbing structure including a first portion, a second portion, a cell, and a pair of flanges. The first portion includes a pair of first flange portions and a first wall portion disposed between the pair of first flange portions. The first portion includes a first thermoset polymer. The second portion includes a second pair of flange portions and a second wall portion disposed between the second pair of flange portions. The second portion includes a second thermoset polymer. The cell includes a cell wall and a first interior region at least partially defined by the cell wall. The cell wall includes the first wall portion and the second wall portion. The pair of flanges includes the pair of first flange portions and the pair of second flange portions, respectively. The first thermoset polymer is cross-linked with the second thermoset polymer at the pair of flanges.

In one aspect, the cell extends along a cell axis between a first end having a first wall thickness and a first maximum dimension and a second end having a second wall thickness and a second maximum dimension. The second end is configured to fail prior to the first end in response to an impact to the cell. At least one of: (i) the second thickness is less than the first thickness, (ii) the second maximum dimension is less than the first maximum dimension, or (iii) the second thickness is less than the first thickness and the second maximum dimension is less than the first maximum dimension.

In one aspect, the cell includes a first cell and a second cell. The first cell has a first stiffness and extends along a first cell axis. The second cell has a second stiffness greater than the first stiffness and extends along a second cell axis. The first cell defines a first length substantially parallel to the first cell axis and a first maximum dimension substantially perpendicular to the first cell axis. The second cell defines a second length substantially parallel to the second cell axis and a second maximum dimension substantially perpendicular to the second cell axis. At least one of (i) the second length is greater than the first length, (ii) the second maximum dimension is greater than the first maximum dimension, or (iii) the second length is greater than the first length and the second maximum dimension is greater than the first maximum dimension.

In one aspect, the energy-absorbing structure further includes a housing including a housing wall and a second interior region, the energy-absorbing structure is disposed within the second interior region and coupled to the housing wall.

In various aspects, the present disclosure provides an energy-absorbing structure including a first portion, a second portion, a third portion, a cell, and a pair of flanges. The first portion includes a first pair of flange portions and a first wall portion disposed between the first pair of flange portion. The first portion includes a first thermoset polymer. The second portion includes a second pair of flange portions and a second wall portion disposed between the second pair of flange portions. The second portion includes a second thermoset polymer. The third portion includes a third thermoset polymer. The cell includes a cell wall and a first interior region at least partially defined by the cell wall. The cell wall includes the first wall portion and the second wall portion. The pair of flanges includes the first pair of flange portions and the second pair of flange portions, respectively. The third thermoset polymer is cross-linked with the first thermoset polymer and the second thermoset polymer at the pair of flanges.

In one aspect, the cell extends along a cell axis between a first end having a first wall thickness and a first maximum dimension and a second end having a second wall thickness and a second maximum dimension. The second end is configured to fail prior to the first end in response to an impact to the cell. At least one of: (i) the second thickness is less than the first thickness, (ii) the second maximum dimension is less than the first maximum dimension, or (iii) the second thickness is less than the first thickness and the second maximum dimension is less than the first maximum dimension.

In one aspect, the cell includes a first cell and a second cell. The first cell has a first stiffness and extends along a first cell axis. The second cell has a second stiffness greater than the first stiffness and extends along a second cell axis. The first cell defines a first length substantially parallel to the first cell axis and a first maximum dimension substantially perpendicular to the first cell axis. The second cell defines a second length substantially parallel to the second cell axis and a second maximum dimension substantially perpendicular to the second cell axis. At least one of (i) the second length is greater than the first length, (ii) the second maximum dimension is greater than the first maximum dimension, or (iii) the second length is greater than the first length and the second maximum dimension is greater than the first maximum dimension.

In one aspect, the energy-absorbing structure further includes a housing including a housing wall and a second interior region, the energy-absorbing structure is disposed within the second interior region and coupled to the housing wall.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a first sectional view of an energy-absorbing assembly according to various aspects of the present disclosure;

FIG. 2 is a perspective view of a housing of the energy-absorbing assembly of FIG. 1;

FIG. 3 is a perspective view of an energy-absorbing component of the energy-absorbing assembly of FIG. 1;

FIG. 4 is a second sectional view of the energy-absorbing assembly of FIG. 1 taken at line 4-4 of FIG. 1;

FIG. 5 is a third sectional view of the energy-absorbing assembly of FIG. 1 taken at line 5-5 of FIG. 1;

FIG. 6 is a sectional view of another energy-absorbing assembly according to various aspects of the present disclosure;

FIG. 7 is a sectional view of a plate of an energy-absorbing assembly according to various aspects of the present disclosure;

FIG. 8 is a sectional view of another energy-absorbing assembly according to various aspects of the present disclosure;

FIG. 9 is a sectional view of yet another energy-absorbing assembly according to various aspects of the present disclosure;

FIG. 10 is a sectional view of yet another energy-absorbing assembly according to various aspects of the present disclosure;

FIG. 11 is a sectional view of yet another energy-absorbing assembly according to various aspects of the present disclosure;

FIG. 12 is a sectional view of yet another energy-absorbing assembly according to various aspects of the present disclosure;

FIG. 13 is a sectional view of yet another energy-absorbing assembly according to various aspects of the present disclosure;

FIG. 14 is a sectional view of yet another energy-absorbing assembly according to various aspects of the present disclosure;

FIG. 15 is a perspective view of an energy-absorbing component according to various aspects of the present disclosure;

FIG. 16 is a perspective view of another energy-absorbing component according to various aspects of the present disclosure;

FIG. 17 is a graph depicting first and second molding steps for forming an energy-absorbing component according to various aspects of the present disclosure;

FIG. 18 is a flowchart depicting a method of manufacturing an energy-absorbing assembly according to various aspects of the present disclosure;

FIG. 19 is a schematic view of a molding process for forming a corrugated component precursor according to various aspects of the present disclosure;

FIG. 20 is a schematic view of a molding process for forming a transverse component precursor according to various aspects of the present disclosure;

FIGS. 21-22 relate to a tailored-viscosity transverse component precursor; FIG. 21 is a perspective view of the precursor; FIG. 22 is a graph depicting viscosity as a function of temperature;

FIGS. 23-24 depict an arranging process for forming an energy-absorbing component according to various aspects of the present disclosure; FIG. 23 is a schematic view; FIG. 24 is a perspective view;

FIG. 25 is a schematic view of an arranging process for forming another energy-absorbing component according to various aspects of the present disclosure;

FIG. 26 is a schematic view of a mandrel placement process for forming an energy-absorbing component according to various aspects of the present disclosure;

FIG. 27 is a schematic view of another mandrel placement process for forming an energy-absorbing component according to various aspects of the present disclosure;

FIG. 28 is a sectional view of an energy-absorbing component according to various aspects of the present disclosure; and

FIG. 29 is a sectional view of another energy-absorbing assembly according to various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

Energy-absorbing assemblies (also referred to as “crush assemblies”) are used in vehicles to absorb collision energy through controlled deformation. Generally, energy-absorbing assemblies may be constructed from metal, such as aluminum or steel, or polymeric materials, such as injection molded polymers or fiber-reinforced polymeric composites. Metal crush members typically absorb energy as molecules slide past one another to deform the component without fracturing. Metal energy-absorbing assemblies may be heavy and complicated compared to composite energy-absorbing assemblies. Metal energy-absorbing assemblies may be time-intensive to assemble because of a large quantity of components. For example, a single metal energy-absorbing assembly may include several bulkheads that are individually fabricated (e.g., by stamping) and fixed to one another (e.g., by welding).

Some polymeric energy-absorbing assemblies are formed by injection molding. Certain geometries, such as corrugated or honeycomb structures may require intricate tooling, and may therefore be difficult to tailor to specific vehicles or loading conditions. Furthermore, injection molded components may be free of reinforcing fibers, or may include very short reinforcing fibers. Some polymeric energy-absorbing assemblies are formed by joining multiple components, which may require less intricate tooling. However, the post-molding joining operations, such as by fasteners and/or adhesive, can increase a complexity of the manufacturing process. Furthermore, such energy-absorbing assemblies may have additional potential failure modes at the joints, which may lead to decreases in crush performance in an impact.

In various aspects, the present disclosure provides energy-absorbing components and assemblies having unitary or continuous structures that are substantially free of joints, seams, adhesive, or mechanical fasteners. The energy-absorbing components may have tailored crush initiation so that failure begins at a desired location. The energy-absorbing components may have tailored stiffness along a longitudinal axis, such as to accommodate vehicle regions having variable stiffness while maintaining a constant overall cross-car stiffness. The present disclosure also provides, in various aspects, methods of manufacturing energy-absorbing assemblies via a two-step molding process, as will be described in greater detail below.

### Energy-Absorbing Assemblies or Structures

With reference to FIGS. 1-5, an energy-absorbing assembly 10 according to various aspects of the present disclosure is provided. The energy-absorbing assembly 10 generally includes an energy-absorbing component 12 and a housing 14. The phrase “energy-absorbing structure” may be used to refer to the energy-absorbing component 12 alone, or the energy-absorbing assembly 10 including the energy-absorbing component 12. The energy-absorbing assembly 10 may be disposed in an orthogonal coordinate system including a first axis 16, a second axis 18, and a third axis 20.

In certain aspects, the energy-absorbing assembly 10 may be a vehicle rocker. When the energy-absorbing assembly 10 is a vehicle rocker, the first axis 16 may be oriented substantially parallel with a longitudinal or fore-aft axis of the vehicle. The second axis 18 may be oriented in a substantially cross-car direction. The third axis 20 may be oriented perpendicular to a surface on which the vehicle is configured to travel (e.g., the third axis 20 may be substantially vertical).

The energy-absorbing component 12 may generally include one or more cells 30, with the cells 30 being spaced apart from one another by flanges 32. Each cell 30 includes a cell wall 34. The cell wall 34 at least partially defines a cell interior region 36. Each cell 30 extends along a cell axis 38. In certain aspects, the cell axes 38 may be substantially parallel to one another and the second axis 18. In one example, the energy-absorbing component 12 includes a plurality of cells 30. In another example, the energy-absorbing component 12 includes a single cell 30 disposed between a pair of flanges 32 or adjacent to a single flange 32.

The energy-absorbing component 12 includes a first corrugated component portion 40 and a second corrugated component portion 42. In certain aspects, the first and second component portions 40, 42 may have substantially the same geometry (e.g., shape and size) such that the second component portion 42 is a mirror image of the first component portion 40 about a center plane (not shown). The first and second component portions 40, 42 may cooperate to form the energy-absorbing component 12 having a unitary structure. Therefore, the energy-absorbing component 12 may be substantially free of joints or seams.

As best shown in FIG. 3, the first component portion 40 includes one or more first wall portions 44 and one or more first flange portions 46. The first wall portions 44 are alternatingly disposed with respect to the first flange portions 46. The first wall portions 44 may at least partially define a ridge or peak. The second component portion 42 includes one or more second wall portions 48 and one or more second flange portions 50. The second wall portions 48 are alternatingly disposed with respect to the second flange portions 50. The second wall portions 48 may at least partially define a trough or valley.

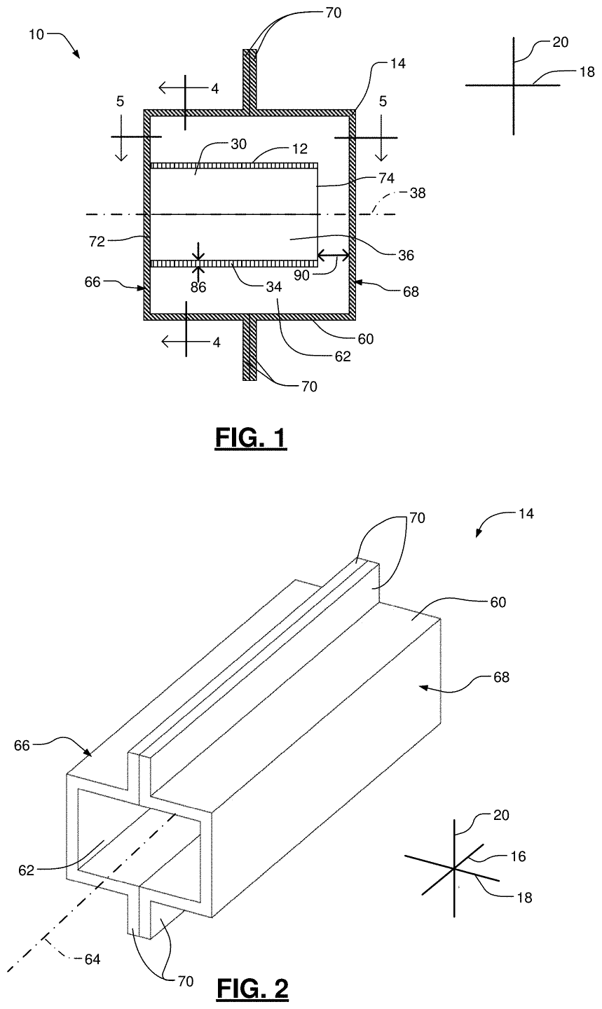

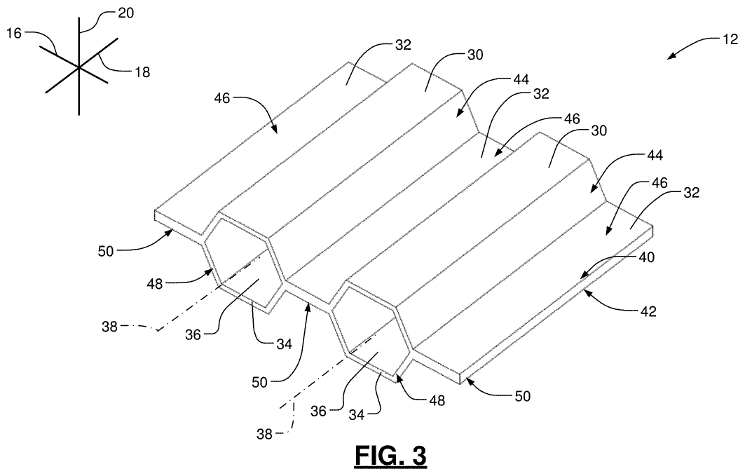

As best shown on FIG. 2, the housing 14 includes a housing wall 60 and a housing interior region 62 at least partially defined by the housing wall 60. The housing wall 60 may extend along a longitudinal housing axis 64. In certain aspects, the longitudinal housing axis 64 may be substantially parallel to the first axis 16.

The housing wall 60 may include a first or inboard housing portion 66 and a second or outboard housing portion 68. The first and second housing portions 66, 68 are coupled to one another, such as at flanges 70. The first housing portion 66 may be configured to be coupled to a vehicle, such as outboard of a floor structure of the vehicle or integrated within the floor structure (e.g., residing above or below the floor structure). Accordingly, the first housing portion 66 may be disposed closer to the vehicle (i.e., inboard) than the second housing portion 68.

The energy-absorbing component 12 is coupled to the housing 14 and disposed within the housing interior region 62 of the housing 14. More particularly, a first end 72 (FIG. 5) of the energy-absorbing component 12 may be coupled to the first housing portion 66. The energy-absorbing component 12 may be coupled to the first housing portion 66 by adhesive, a plurality of fasteners, snap-in features, and/or mechanical interlocks, by way of example. A second end 74 (FIG. 5) of the energy-absorbing component 12 may be spaced apart from the second housing portion 68. In various alternative aspects, an energy-absorbing component may extend across substantially an entire width of a housing between first and second housing portions (not shown). The energy-absorbing component may optionally be coupled to both of the first and second housing portions.

In some embodiments, an energy-absorbing assembly includes a single energy-absorbing component. In some embodiments, an energy-absorbing assembly includes a plurality of energy-absorbing components along a length of a housing (i.e., parallel to a longitudinal housing axis). The energy-absorbing assembly may include a single row of energy-absorbing components. In some examples, the energy-absorbing components are evenly distributed along an entire length of the housing. In other examples, the energy-absorbing elements are unevenly distributed depending vehicle stiffness and desired crush performance. In some embodiments, an energy-absorbing assembly includes multiple rows of energy-absorbing components along a vertical axis.

### Materials

The energy-absorbing assembly 10 is formed from fiber-reinforced composite materials. Fiber-reinforced composite materials include a polymeric matrix having a reinforcing material distributed therein. Generally, fiber-reinforced composite crush members absorb energy through fragmentation, pulverization, fronding, tearing, interlaminar debonding, intralaminar debonding, fiber-matrix debonding, and fiber pullout failure modes, by way of non-limiting example.

In various aspects, the first component portion 40 includes a first polymer composite including a first polymer and a first plurality of reinforcing fibers. The second component portion 42 includes a second polymer composite including a second polymer and a second plurality of reinforcing fibers. In certain aspects, the first and second component portions each include a thermoset polymer (e.g., epoxy) and carbon fibers.

Suitable reinforcing materials include carbon fibers, glass fibers (e.g., fiber glass, quartz), basalt fibers, aramid fibers (e.g., KEVLAR®, polyphenylene benzobisoxazole (PBO)) polyethylene fibers (e.g., high-strength ultra-high molecular weight (UBMW) polyethylene), polypropylene fibers (e.g., high-strength polypropylene), natural fibers (e.g., cotton, flax, cellulose, spider silk), and combinations thereof, by way of non-limiting example. The reinforcing materials may be fabricated as woven fabric, continuous random fabric, discontinuous random fibers, chopped random fabric, continuous strand unidirectional plies, oriented chopped strand plies, braided fabric and any combinations thereof.

In certain aspects, the first polymer is formed from a first polymer resin and the second polymer is formed from a second polymer resin. The housing 14 may include a third polymer, a third polymer composite (including a third polymer and a third plurality of reinforcing fibers), and/or a metal (e.g., steel, aluminum, magnesium. The third polymer may be formed from a third polymer resin. The first, second, and third polymers may be the same or different. In one example, the first, second, and third polymers are all the same. In another example, the first and second polymers are the same and the third polymer is different. In yet another example, each of the first, second, and third polymers is different.

The first and second polymers may both be thermoset polymers or the first and second polymers may both be thermoplastic polymers. The third polymer may be a thermoset polymer or a thermoplastic polymer independent of whether the first and second polymers are thermoset polymers or thermoplastic polymers.

Suitable thermoset polymers include: benzoxazine, a bis-maleimide (BMI), a cyanate ester, an epoxy, a phenolic (PF), a polyacrylate (acrylic), a polyimide (PI), an unsaturated polyester, a polyeurethane (PUR), a vinyl ester, a siloxane, polydicyclopentadiene (PDCPD), co-polymers thereof, and combinations thereof. When the first and second polymers are thermoset polymers, the first and second polymers are cross-linked at the flanges 32, thereby directly coupling the first and second component portions 40, 42 to form a continuous or unitary structure.

Suitable thermoplastic polymers may include: polyethylenimine (PEI), polyamide-imide (PAI), polyamide (PA) (e.g., nylon 6, nylon 66, nylon 12), polyetheretherketone (PEEK), polyetherketone (PEK), a polyphenylene sulfide (PPS), a thermoplastic polyurethane (TPU), polypropylene (PP), polycarbonate/acrylonitrile butadiene styrene (PC/ABS), high-density polyethylene (HDPE), polyethylene terephthalate (PET), poly(methyl methacrylate) (PMMA), polycarbonate (PC), polyaryletherketone (PAEK), polyetherketoneketone (PEKK), co-polymers thereof, and combinations thereof.

### Dimensions

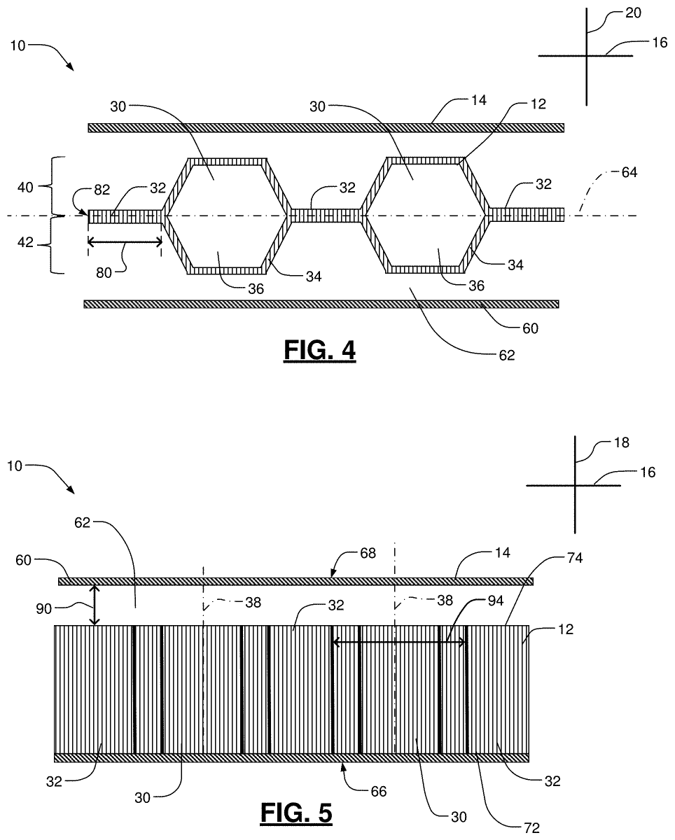

In certain aspects, as shown in FIG. 4, each flange 32 may have a width 80 that facilitates substantially uniform application of pressure to the flange 32 during manufacturing, as will be described in greater detail below. The width 80 may be defined substantially parallel to the first axis 16 and the longitudinal housing axis 64. For example, the width 80 may be a shortest distance of the flange 32 between the cell wall 34 and a distal end 82 of the flange 32. The width 80 may be greater than or equal to about 0.1 mm to facilitate the uniform application of pressure during molding. In certain aspects, the width 80 may be greater than or equal to about 1 mm, optionally greater than or equal to about 5 mm, or optionally greater than or equal to about 10 mm. In certain aspects, the width 80 may be less than or equal to about 300 mm.

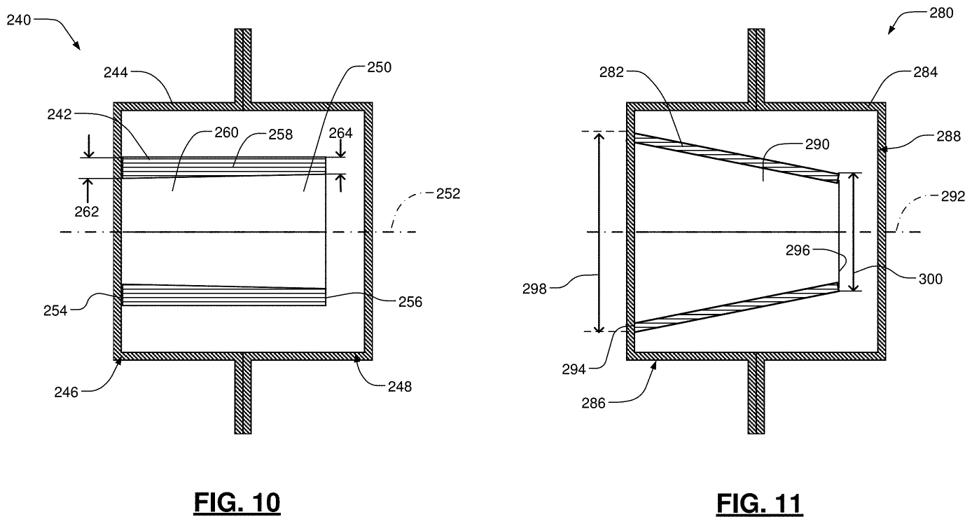

The first and second wall portions 44, 48 each define a thickness. The thickness may be uniform or variable (see, e.g., FIG. 10). In certain aspects, the first and second wall portions 44, 48 define an average thickness 86 (FIG. 1) of greater than or equal to about 1 mm to less than or equal to about 10 mm, optionally greater than or equal to about 1.5 mm to less than or equal to about 8 mm, or optionally greater than or equal to about 2 mm to less than or equal to about 6 mm.

As best shown in FIG. 5, the second end 74 of the energy-absorbing component 12 may be spaced apart from the second housing portion 68 by a gap 90, as best shown in FIG. 5. In certain aspects, the gap 90 may be greater than or equal to about 1 mm to less than or equal to about 30 mm, optionally greater than or equal to about 2 mm to less than or equal to about 20 mm, or optionally greater than or equal to about 5 mm to less than or equal to about 10 mm. The cells 30 may define a maximum cell cross-dimension 94 substantially perpendicular to the cell axes 38. In certain aspects, the maximum cell cross-dimension 94 may be greater than or equal to about 20 mm to less than or equal to about 300 mm, optionally greater than or equal to about 25 mm to less than or equal to about 250 mm, or optionally greater than or equal to about 30 mm to less than or equal to about 200 mm. When an energy-absorbing component includes cells having substantially circular cross sections perpendicular to cell axes, a maximum cell cross-dimension is a diameter.

Energy-Absorbing Assemblies or Structures with Transverse Components

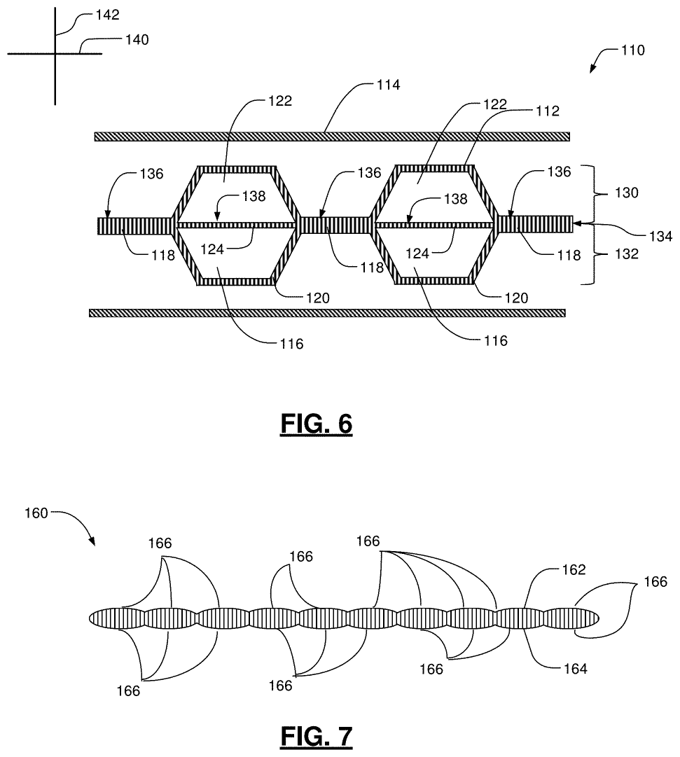

In various aspects, the present disclosure provides energy-absorbing components including transverse plates that increase a stiffness of the energy-absorbing components, thereby increasing a force of impact necessary to initiate failure or crush. Referring to FIG. 6, another energy-absorbing assembly 110 according to various aspects of the present disclosure is provided. Unless otherwise described, the energy-absorbing assembly 110 is similar to the energy-absorbing assembly 10 of FIGS. 1-5. The energy-absorbing assembly 110 includes an energy-absorbing component 112 and a housing 114.

The energy-absorbing component 112 generally includes one or more cells 116 and one or more flanges 118 alternatingly disposed with respect to the one or more cells 116. Each cell 116 includes a cell wall 120 at least partially defining a cell interior region 122. A transverse plate 124 extends through at least a portion of the cell interior regions 122 (e.g., all of the cell interior regions 122).

The energy-absorbing assembly 110 has a unitary structure formed from a first corrugated component portion 130 similar to the first component portion 40 of FIG. 3, a second corrugated component portion 132 similar to the second component portion 42 of FIG. 3, and a third or transverse component portion 134. The third component portion 134 is disposed between the first and second component portions 130, 132.

The first component portion 130 includes wall portions and flange portions, similar to the first wall portions 44 and first flange portions 46 of the energy-absorbing component 12 of FIG. 3. The second component portion 132 includes wall and flange portions, similar to the second wall portions 48 and the second flange portions 50 of the energy-absorbing component 12 of FIG. 3. The third component portion 134 includes joining portions 136 that aligned between the flange portions of the first and second component portions 130, 132. The third component portion 134 further includes core portions 136 that are aligned between the wall portions of the first and second component portions 130, 132. The joining and core portions 136, 138 are integrally-formed regions of the third component portion 134. The names “joining portion” and “core portion” may describe placement within the energy-absorbing assembly 110.

The cell walls 120 include wall portions of the first and second component portions 130, 132. The flanges 118 include flange portions of the first and second component portions 130, 132 and joining portions 136 of the third component portion 134. The transverse plates 124 include core portions 138 of the third component portion 134.

The third component portion 134 may extend in a longitudinal direction substantially parallel to a longitudinal axis 140 and a cross-car direction substantially parallel to a cross-car axis (see, e.g., second axis 18 of FIG. 3). In certain aspects, the third component portion 134, and therefore also the transverse plates 124, may extend through a vertical center (i.e., center along a vertical axis 142) of the cell interior regions 122. Accordingly, the third component portion 134 and/or transverse plates 124 may be referred to as mid-plane components. The third component portion 134 may be formed from a plate (see, e.g., transverse precursor portion 610, 630 of FIGS. 20, 21, respectively) such that it is substantially planar.

The third component portion 134 may be formed from a polymer and a plurality of reinforcing fibers similar to the polymers and reinforcing fibers discussed above in conjunction with FIGS. 1-5. More particularly, the first component portion 130 may include a first polymer and a first plurality of reinforcing fibers, the second component portion 132 may include a second polymer and a second plurality of reinforcing fibers, and the third component portion 134 may include a third polymer and third plurality of reinforcing fibers. The third polymer may be the same as or different than the first and/or second polymers and/or reinforcing fibers.

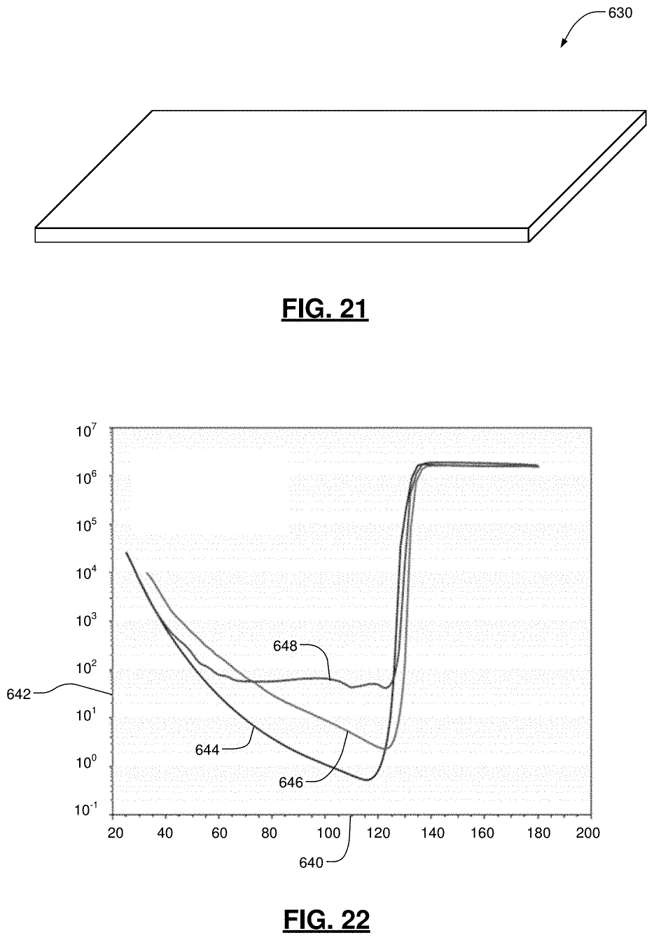

In a first example, the first, second, and third polymers are independently-selected thermoset polymers. In certain aspects, the first and second polymers may be the same thermoset polymer and the third polymer may be a different thermoset polymer (e.g., a thermoset polymer having tailored viscosity, as discussed in greater detail below in conjunction with FIGS. 21-22). In certain aspects, the third polymer may have a different degree of cure (DOC) than the first and second polymers. In certain aspects, the first, second, and third polymers may include the same thermoset polymer. In a second example, the first and second polymers are independently-selected thermoset polymers and the third polymer is a thermoplastic polymer. In a third example, the first and second polymers are independently-selected thermoplastic polymers and the third polymer is a thermoplastic polymer.

In various aspects, a transverse component portion may include one or more features to facilitate bonding and/or adhesion to first and second component portions. The transverse component may include a plurality of reinforcing fibers. In some examples, at least a portion of a third plurality of reinforcing fibers of the third component portion are oriented substantially parallel to a thickness of a flange (i.e., substantially parallel to a vertical axis).

In other examples, a third or transverse component may include textured surfaces, roughened surfaces having a plurality of ridges, or any combination thereof. Textured surfaces may include cross-hatching, knurling, dimpling, swirls, spiraling, or any combination thereof, by way of example. Roughened surfaces may have an average roughness of at least 0.1 μm. In certain aspects, the average roughness may be greater than or equal to about 0.2 μm to less than or equal to about 10 μm, optionally the roughness may be greater than or equal to about 0.3 μm to less than or equal to about 8 μm, or optionally the roughness may be greater than or equal to about 0.4 μm to less than or equal to about 6 μm. With reference to FIG. 7, another transverse component portion 160 according to various aspects of the present disclosure is provided. The transverse component portion 160 includes a first surface 162 and a second surface 164. The first and second surfaces 162, 164 each include a plurality of ridges 166. The ridges 166 may be disposed substantially parallel to one another.

### Cell Shapes

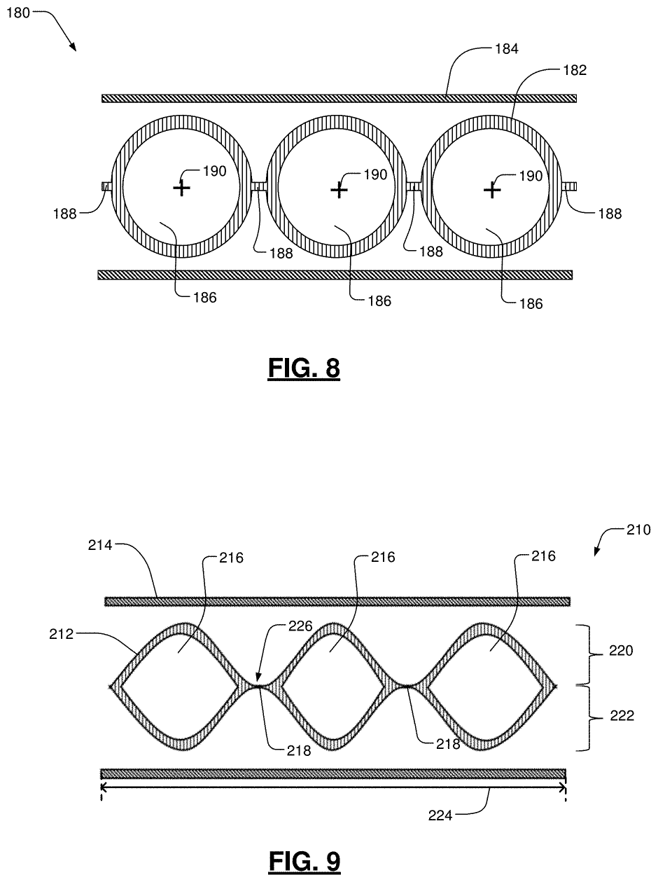

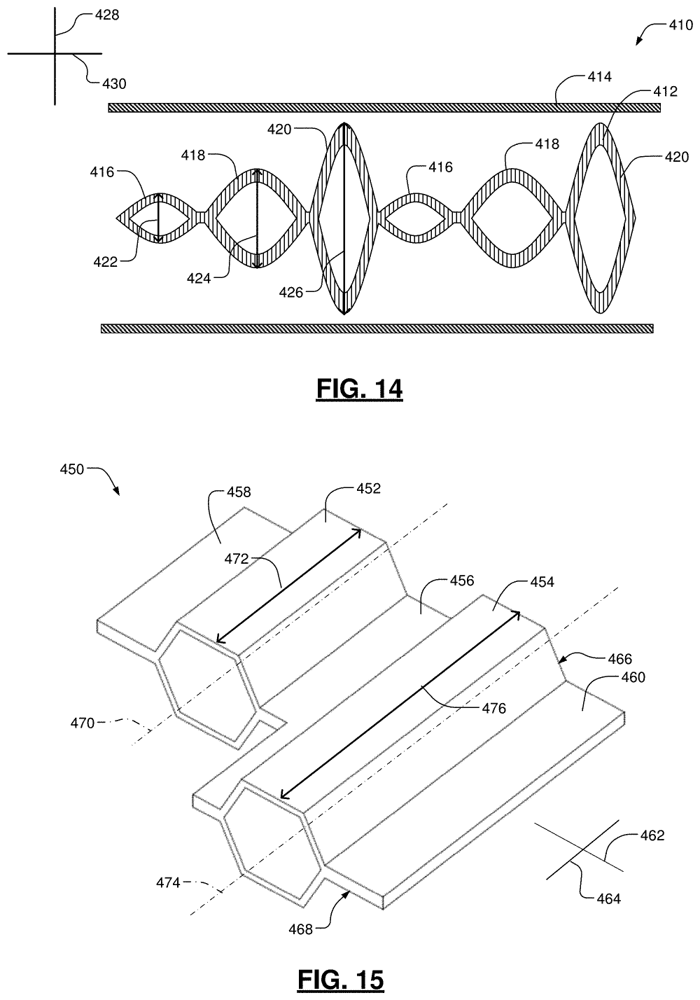

Cells of energy-absorbing components according to various aspects of the present disclosure may be a variety of shapes and sizes. Cells may define cross-sectional shapes substantially perpendicular to respective cell axes. Cross-sectional shapes may include hollow circles (FIG. 8), triangles, quadrilaterals (e.g., rectangles, diamonds), pentagons, hexagons (FIG. 3), heptagons, octagons, nonagons, or decagons, by way of example. An energy-absorbing component may include more than one cross-sectional shape along its length, such as for tailored stiffness, which is discussed in greater detail below in conjunction with FIGS. 14-15. Furthermore, an energy-absorbing assembly may include a plurality of energy-absorbing components having cells with different cross-sectional shapes.

Referring to FIG. 8, another energy-absorbing assembly 180 according to various aspects of the present disclosure is provided. Unless otherwise described, the energy-absorbing assembly 180 may be similar to the energy-absorbing assembly 110 of FIGS. 1-5. The energy-absorbing assembly 180 includes an energy-absorbing component 182 and a housing 184. The energy-absorbing component 182 includes one or more cells 186 and one or more flanges 188 alternatingly disposed with respect to the flanges 188. The cells 186 extend along respective cell axes 190. The cells 186 define hollow circular cross-sectional shapes substantially perpendicular to the respective cell axes 190.

In various aspects, surfaces of an energy-absorbing component may be smooth, having smooth transitions between cells and flanges. With reference to FIG. 9, yet another energy-absorbing assembly 210 according to various aspects of the present disclosure is provided. The energy-absorbing assembly 210 may include an energy-absorbing component 212 and a housing 214. Unless otherwise described, the energy-absorbing assembly 210 may be similar to the energy-absorbing assembly 10 of FIGS. 1-5.

The energy-absorbing component 212 includes one or more cells 216 and one or more flanges 218. The energy-absorbing assembly 210 includes a first component portion 220 and a second component portion 222. The first and second component portions 220, 222 define waveform shapes such that the energy-absorbing component 212 includes a smooth transition between the cells 216 and flanges 218. Accordingly, the energy-absorbing component 212 may exhibit substantially uniform performance along a length 224 (i.e., substantially parallel to a longitudinal axis) and perform well in failure or crush.

Each flanges 218 may define a radius 226. The radius 226 may be greater than or equal to about 1 mm to facilitate an even distribution of pressure during manufacturing. In certain aspects, the radius may be greater than or equal to about 2 mm to less than or equal to about 20 mm.

### Tailored Crush Initiation

In various aspects, energy-absorbing components may be configured for tailored crush or failure initiation. More particularly, energy-absorbing components may be configured to initiate crush on an outboard end of the cells, such as by differences in cross-dimension (e.g., diameter) (FIGS. 11-13), cell wall thickness (FIG. 10), wall angle with respect to a cell axis, and/or shape. Referring to FIG. 10, yet another energy-absorbing assembly 240 according to various aspects of the present disclosure is provided. Unless otherwise described, the energy-absorbing assembly 240 may be similar to het energy-absorbing assembly 10 of FIGS. 1-5.

The energy-absorbing assembly 240 includes an energy-absorbing component 242 and a housing 244. The housing 244 may generally include a first or inboard housing portion 246 and a second or outboard housing portion 248 coupled to the first housing portion 246. The energy-absorbing component 242 is coupled to the first housing portion 246.

The energy-absorbing component 242 includes one or more cells 250, each extending along a cell axis 252 between a first end 254 and a second end 256. Each cell 250 includes a cell wall 258 at least partially defining a cell interior region 260. The cell wall 258 defines a first thickness 262 at the first end 254 and a distinct second thickness 264 at the second end 256. The second thickness 264 is less than the first thickness 262 to facilitate crush initiation at the second end 256 prior to the first end 254.

With reference to FIG. 11, yet another energy-absorbing assembly 280 according to various aspects of the present disclosure is provided. Unless otherwise described, the energy-absorbing assembly 280 may be similar to the energy-absorbing assembly 10 of FIGS. 1-5. The energy-absorbing assembly 280 includes an energy-absorbing component 282 and a housing 284. The housing 284 may generally include a first or inboard housing portion 286 and a second or outboard housing portion 288 coupled to the first housing portion 286. The energy-absorbing component 282 is coupled to the first housing portion 286.

The energy-absorbing component 242 includes one or more cells 290, each extending along a cell axis 292 between a first end 294 and a second end 296. The first end 294 defines a first maximum cross-dimension 298 (e.g., first diameter) and the second end 296 defines a distinct second maximum cross-dimension 300 (e.g., second diameter). The second maximum cross-dimension 300 may be smaller than the first maximum cross-dimension 298 to facilitate crush initiation at the second end 296 prior to the first end 294.

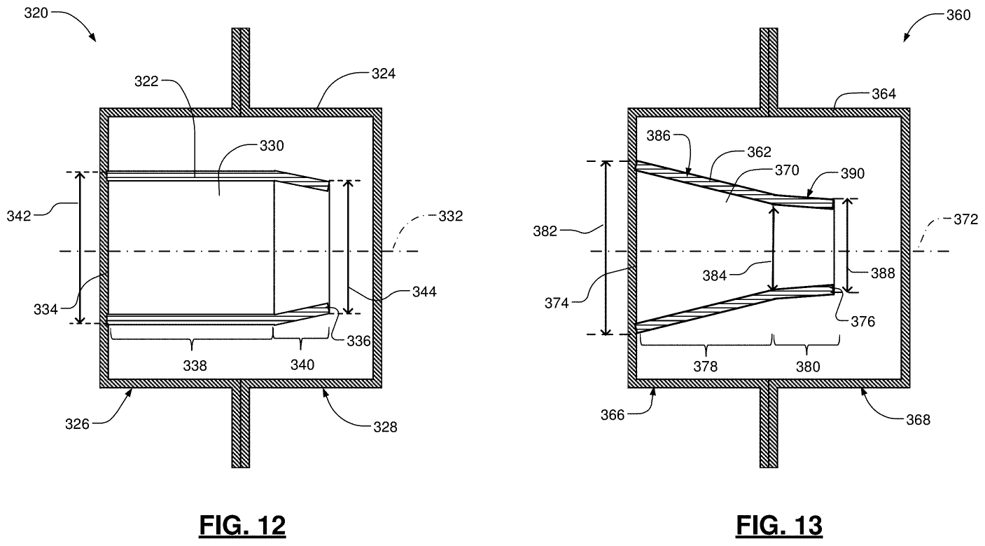

Referring to FIG. 12, yet another energy-absorbing assembly 320 according to various aspects of the present disclosure is provided. Unless otherwise described, the energy-absorbing assembly 320 may be similar to the energy-absorbing assembly 10 of FIGS. 1-5. The energy-absorbing assembly 320 includes an energy-absorbing component 322 and a housing 324. The housing 324 includes a first or inboard housing portion 326 and a second or outboard housing portion 328.

The energy-absorbing component 322 includes one or more cells 330 extending along respective cell axes 332. Each cell 330 extends between a first end 334 and a second end 336, with the first end 334 being coupled to the first housing portion 326. Each cell 330 includes a first cell portion 338 and a second cell portion 340, with the first cell portion 338 being disposed inboard of the second cell portion 340. In certain aspects, a cell may include more than two portions along a cell axis.

The first cell portion 338 may have a substantially-constant first cross-dimension 342. The second cell portion 340 may be tapered (e.g., frusto-conical) between the first cross-dimension 342 adjacent to the first cell portion 338 and a second cross-dimension 344 at the second end 336. The second cross-dimension 344 may be smaller than the first cross-dimension 342 to facilitate crush initiation at the second end 336 prior to the first end 334. In certain alternative aspects, a first portion may be tapered and a second portion may have a substantially-constant diameter.

With reference to FIG. 13, yet another energy-absorbing assembly 360 according to various aspects of the present disclosure is provided. Unless otherwise described, the energy-absorbing assembly 360 may be similar to the energy-absorbing assembly 10 of FIGS. 1-5. The energy-absorbing assembly 360 includes an energy-absorbing component 362 and a housing 364. The housing 364 includes a first or inboard housing portion 366 and a second or outboard housing portion 368.

The energy-absorbing component 362 includes one or more cells 370 extending along respective cell axes 372. Each cell 370 extends between a first end 374 and a second end 376, with the first end 374 being coupled to the first housing portion 366. Each cell 370 includes a first cell portion 378 and a second cell portion 380, with the first cell portion 378 being disposed inboard of the second cell portion 380. In certain aspects, a cell may include more than two portion along a cell axis.

The first cell portion 378 may be tapered (e.g., frusto-conical) between a first cross-dimension 382 at the first end 374 and a second cross-dimension 384 adjacent to the second cell portion 380. The first cell portion 378 may include a first wall portion 386 that forms a first angle with respect to the cell axis 372.

The second cell portion 380 may be tapered (e.g., frusto-conical) between the second cross-dimension 384 adjacent to the first cell portion 378 and a third cross-dimension 388 at the second end 376. The third cross-dimension 388 may be smaller than the second cross-dimension 384 to facilitate crush initiation at the second end 376 prior to the first end 374. The second cell portion 380 may include a second wall portion 390 that forms a second angle with respect to the cell axis 372. The first and second angles may have distinct magnitudes. The second angle may have a smaller magnitude than the first angle. In certain alternative aspects, a second angle may have a large magnitude than a first angle.

### Tailored Stiffness

Cross-car stiffness of vehicle components, such as at a vehicle floor, may vary along a longitudinal axis of the vehicle. For example, a vehicle floor may have a higher stiffness at a local reinforcement and a lower stiffness at a region away from the local reinforcement. However, in some situations, it may be advantageous to absorb the same total amount of energy at each impact location for the vehicle as a whole. In some designs, a local force to initiate failure, thereby absorbing impact energy, of an energy-absorbing component is lower than a force to initiate crush/buckling failure of a floor structure and its reinforcements to facilitate failure of the energy-absorbing component before the floor structure.

Total energy absorbed by a structure is a function of its material and design (e.g., shape and/or size). It may be advantageous to maximize energy absorbed by the energy-absorbing assembly with a uniform material (e.g., fiber-reinforced composite) throughout the energy-absorbing structure. Therefore, geometry of an energy-absorbing component may be non-uniform to control a force required to initiate failure. In general, less stable structures will initiate failure at a lower impact force, yet place more material in a path of an impact so that total energy absorbed is the same along an entire length of the energy-absorbing assembly.

In various aspects, an energy-absorbing assembly and/or component may have tailored stiffness. More particularly, stiffness may be non-uniform across a length (i.e., substantially parallel to a longitudinal axis) of an energy-absorbing assembly or component. Stiffness may be tailored by cell height variation (FIG. 14), cell length variation (FIG. 15), and/or distribution of energy-absorbing components within a housing. Referring to FIG. 14, yet another energy-absorbing assembly 410 according to various aspects of the present disclosure is provided. Unless otherwise described, the energy-absorbing assembly 410 may be similar to the energy-absorbing assembly 10 of FIGS. 1-5.

The energy-absorbing assembly 410 includes an energy-absorbing component 412 and a housing 414. The energy-absorbing component 412 includes a plurality of cells alternatingly distributed with a plurality of flanges. The cells have varying heights and corresponding varying stiffnesses. More particularly, the plurality of cells may include a first plurality of cells 416, a second plurality of cells 418, and a third plurality of cell 420. In various alternative aspects, an energy-absorbing component may include fewer than three pluralities of cells having distinct stiffnesses, or greater than three pluralities of cells having distinct stiffnesses. Moreover, the pluralities may be distributed as needed according to vehicle design and need not repeat as a recurring pattern.

The first, second, and third pluralities of cells 416, 418, 420 have respective first, second, and third maximum dimensions 422, 424, 426, and respective first, second, and third stiffnesses. In certain aspects, the maximum dimensions 422, 424, 426 may be measured substantially parallel to a vertical axis 428. The second maximum dimension 424 may be greater than the first maximum dimension 422. Therefore, the second stiffness may be greater than the first stiffness. The third maximum dimension 426 may be greater than the second maximum dimension 424. Therefore, the third stiffness may be greater than the second stiffness.

In one example, the energy-absorbing assembly 410 is coupled to a vehicle adjacent to a vehicle floor. The first plurality of cells 416 may be aligned with a highest stiffness region of the vehicle floor along a longitudinal axis 430. The second plurality of cells 418 may be aligned with an intermediate stiffness region of the vehicle floor along the longitudinal axis 430. The third plurality of cells 420 may be aligned with a lowest stiffness region of the vehicle floor along the longitudinal axis 430. Accordingly, the vehicle as a whole may have substantially uniform energy-absorption characteristics at each location along the longitudinal axis 430.

With reference to FIG. 15, yet another energy-absorbing component 450 according to various aspects of the present disclosure is provided. Unless otherwise described, the energy-absorbing component 450 may be similar to the energy-absorbing component 12 of FIG. 3. The energy-absorbing component 450 includes at least one first cell 452, at least one second cell 454, a first flange 456, a second flange 458, and a third flange 460. The first flange 456 is disposed between the first and second cells 452, 454. The first cell 452 is disposed between the first and second flanges 456, 458. The second cell 454 is disposed between the first and third flanges 456, 460. In various alternative aspects, an energy-absorbing component may have greater than two cells having distinct stiffnesses.

The energy-absorbing component 450 may extend along a longitudinal axis 462 within a housing (not shown). The energy-absorbing component 450 may extend along a cross-car axis 464 between a first end 466 configured to be coupled to the housing and a second end 468. The first cell 452 extends along a first cell axis 470 substantially parallel to the cross-car axis 464. The first cell 452 defines a first length 472 along the first cell axis 470. The second cell 454 extends along a second cell axis 474 substantially parallel to the cross-car axis 464. The second cell 454 defines a second length 476 along the second cell axis 474. The second length 476 and the first length 472 are distinct. The second length 476 may be greater than the first length 472 such that the second cell 454 has a greater stiffness that the first cell 452.

In one example, the energy-absorbing component 450 is coupled to a vehicle adjacent to a vehicle floor. The first cell 452 may be aligned with a highest stiffness region of the vehicle floor along the longitudinal axis 462. The second cell 454 may be aligned with a maximum stiffness region of the vehicle floor along the longitudinal axis 462. Accordingly, the vehicle as a whole may have substantially uniform energy-absorption characteristics at both locations along the longitudinal axis 462.

### Additional Features

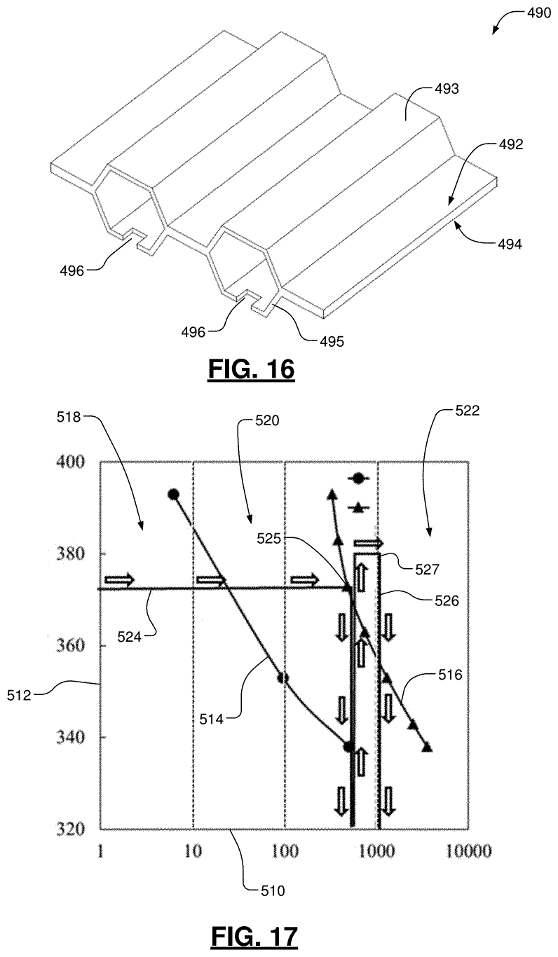

Referring to FIG. 16, another energy-absorbing component 490 according to various aspects of the present disclosure is provided. Unless otherwise described, the energy-absorbing component 490 may be similar to the energy-absorbing component 12 of FIG. 3. The energy-absorbing component 490 includes a first component portion 492 having a first cell wall 493 and a second component portion 494 having a second cell wall 495. At least one of the first and second cell walls 493, 495 (e.g., the second cell wall 495) defines an opening, such as a weep opening 496. The weep opening 496 may facilitate draining of liquids, such as due to rain water or manufacturing (e.g., from a material treatment coating or bath). Openings can be molded or formed in post-processing.

Methods of Manufacturing Energy-Absorbing Components via Two-Step Molding

In various aspects, the present disclosure provides methods of manufacturing energy-absorbing assemblies in a two-step molding process. Component precursor portions are formed in a first molding step and joined in a second molding step to form a unitary energy-absorbing component, thereby eliminating a need for post-molding joining operations, such as adhesive and/or mechanical fasteners. When first and second polymers are thermoplastic polymers, the component precursor portions are molded at a first temperature and joined at a second temperature greater or equal to than the first temperature. Alternatively, when first and second polymers are thermoplastic polymers, component precursors may be molded in a one-step process. When the first and second polymers are thermoset polymers and a transverse component precursor includes a third polymer that is a thermoplastic polymer, the thermoset and thermoplastic polymers may react and form linkages to join the components.

When the first and second polymers are thermoset polymers, the component precursor portions are molded to a first DOC and joined at a second DOC greater than the first DOC. DOC is defined as a ratio of reacted polymer (in J/g) to total potential reaction (in J/g) (if all polymer is reacted). Accordingly, the first and second polymers are cross-linked at the joints. With reference to FIG. 17, a graph depicting a two-step thermoset molding process according to various aspects of the present disclosure is provided. An x-axis 510 represents gel or vitrification time in minutes. A y-axis 512 represents isothermal temperature in K. A first curve 514 represents gelation for a representative thermoset polymer. A second curve 516 represents vitrification for the representative thermoset polymer. In a first region 518, the representative thermoset polymer is a liquid. In a second region 520 between gelation and vitrification, the representative thermoset polymer is a sol/gel rubber. In a third region 522, the representative thermoset polymer is a gelled glass.

In the example shown, a first molding step 524 holds the representative thermoset polymer at a constant temperature until vitrification (shown at first DOC 525) and then cools the representative thermoset polymer. A second molding step 526 raises the representative thermoset polymer to a higher temperature to reach a higher DOC (shown at second DOC 527) and then cools the representative thermoset polymer. Methods according to various aspects of the present disclosure may use alternative paths to reach first and second DOCs. For example, methods may include isothermal heating, as shown, or dynamic heating). The first and second molding steps may also include the application of pressure to all or portions of the representative thermoset polymer.

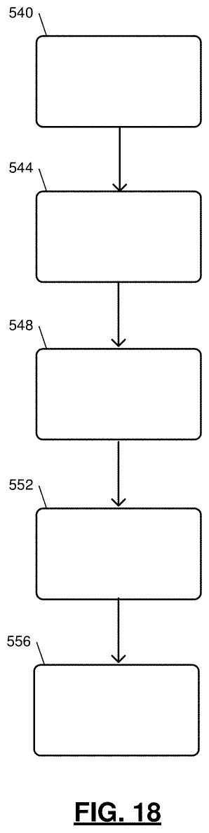

Referring to FIG. 18, a flowchart depicting a method of manufacturing an energy-absorbing assembly via two-step molding according to various aspects of the present disclosure is provided. The method generally includes molding or obtaining component precursors at 540, arranging component precursors in a mold at 544, joining component precursors at 546 to form an energy-absorbing component, optionally performing post-processing steps at 552, and optionally coupling the energy-absorbing component to a housing at 556. Each of these method steps is described in greater detail below.

### Molding or Obtaining Component Precursors

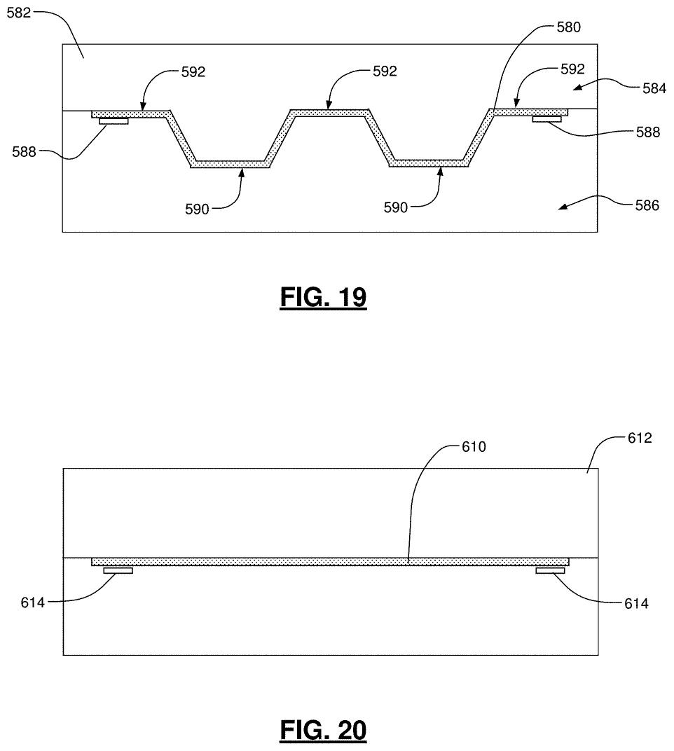

At 540, the method includes molding or obtaining component precursors. With reference to FIG. 19, a corrugated component precursor 580 is formed in a mold 582 according to various aspects of the present disclosure. The mold 582 may include a first or male portion 584 and a second or female portion 586. The mold 582 may include dielectric cure sensors 588 and/or average mold temperature sensors (not shown). In some examples, average mold temperature may be a set point.

The component precursor 580 may be a first component precursor or a second component precursor. In certain aspects, first and second component precursors may be identical. The method may include forming a plurality of component precursors to be used in subsequent operations. The component precursor 580 includes one or more wall portions 590 and one or more flange portions 592 alternatingly disposed with respect to the wall portions 590.

Molding the composite precursor 580 includes applying heat and pressure to the polymer resin. When the polymer resin is a thermoset polymer resin, molding causes partial cross-linking such that the thermoset polymer resin has a first DOC. The first DOC is greater than 0 and less than 1. At the first DOC, the thermoset polymer resin has been vitrified and is a gelled glass. DOC may be monitored based on output from the dielectric cure sensor 588 and/or average mold temperature, time in mold, and molding pressure. When the polymer resin is a thermoplastic polymer resin, molding includes heating the thermoplastic polymer resin to a first temperature less than a melting temperature of the thermoplastic polymer.

Referring to FIG. 20, a transverse component precursor 610 is formed in a mold 612 according to various aspects of the present disclosure. The mold 612 may include dielectric cure sensors 614 and/or average mold temperature sensors (not shown). In some examples, average mold temperature may be a set point. The transverse component precursor 610 may be substantially planar. Molding may include applying heat and pressure to a thermoset or thermoplastic polymer resin as described above with respect to molding the corrugated component precursors 580.

With reference to FIG. 21, a transverse component precursor 630 may be provided without performing an initial molding step to partially cure a thermoset polymer resin according to various aspects of the present disclosure. For example, the initial molding step (e.g., as described in conjunction with FIG. 21), may be omitted when the transverse component precursor 630 has a sufficiently high viscosity to withstand handling. The transverse component precursor 630 may have a DOC of 0 and be in a sol/gel rubber state.

With reference to FIG. 22, a graph showing viscosity as a function of temperature according to various aspects of the present disclosure is provided according to various aspects of the present disclosure. An x-axis 640 represents temperature in ° C. A y-axis 642 represents complex viscosity in Pa·s. First, second, and third curves 644, 646, 648 correspond to first, second, and third representative thermoset resins. As shown in the graph, it is possible to tailor viscosity of thermoset resins. In certain aspects, viscosity may be tailored by adding filler materials, such as silica, carbon black, or chemical thickening chain structure agent. In certain aspects, a transverse component precursor 630 has a viscosity of greater than or equal to about 100 Pa·s at a molding temperature, optionally greater than or equal to about 150 Pa·s at room temperature, or optionally greater than or equal to about 180 Pa·s at room temperature.

### Arranging Component Precursors in Mold

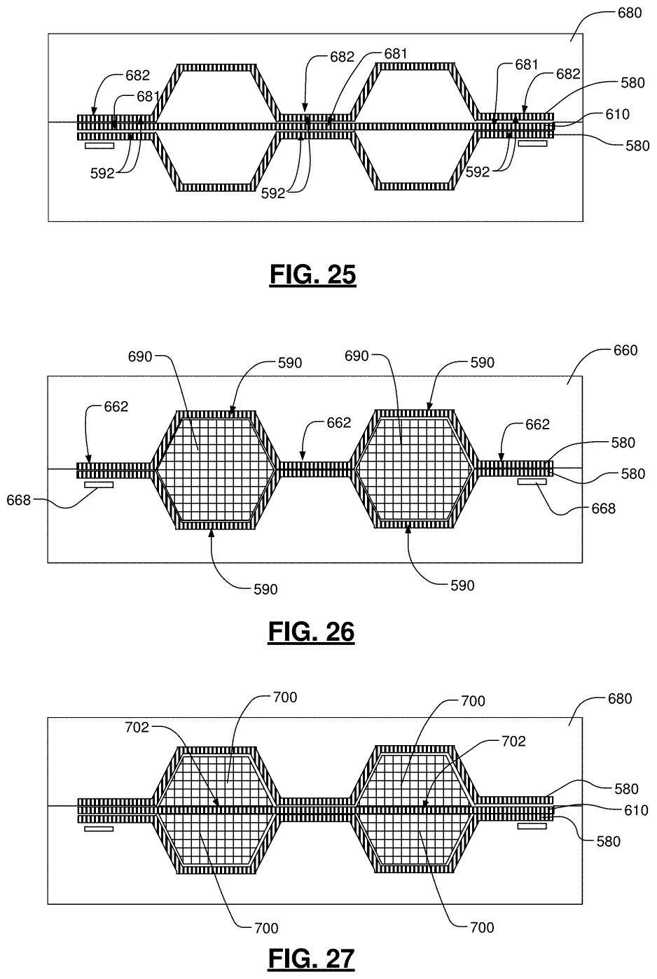

Returning to FIG. 18, at 544, the method includes arranging component precursors in a mold. FIGS. 23-25 relate to arranging component precursors including thermoset polymer resins in molds without the use of mandrels to maintain spacing between component precursors according to various aspects of the present disclosure. FIGS. 26-27 relate to arranging component precursors including thermoset or thermoplastic polymer resins in molds using mandrels to maintain spacing between component precursors according to various aspects of the present disclosure.

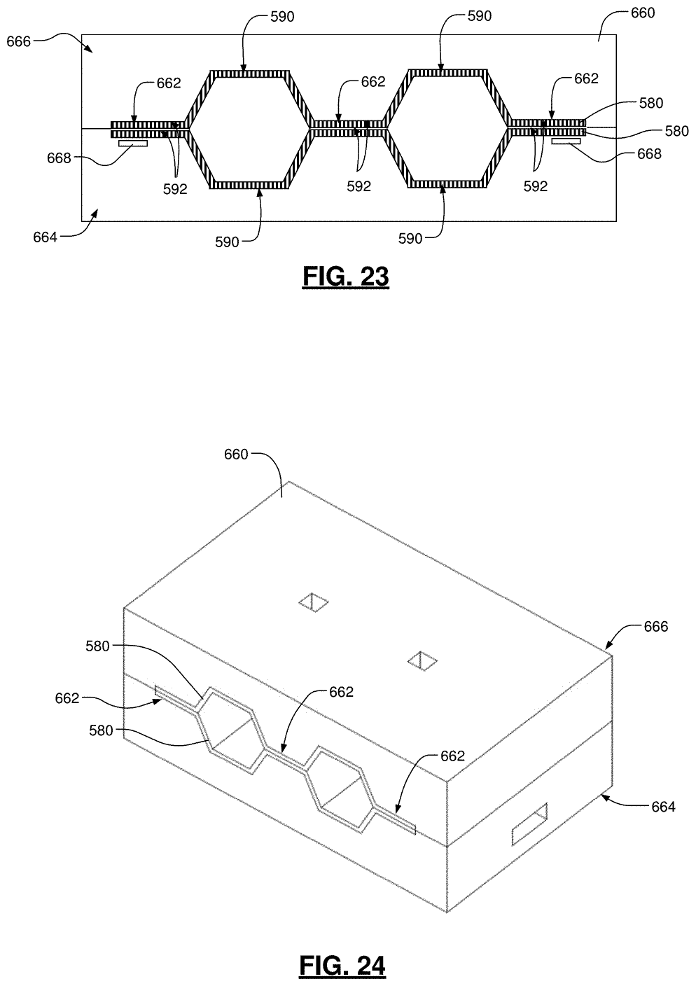

Referring to FIGS. 23-24, corrugated component precursors 580 may be arranged in a mold 660. Flange portions 592 of the corrugated component precursors 580 may be in direct contact in respective joining regions 662. The mold 660 may include a first female portion 664, a second female portion 666, and one or more dielectric cure sensors 668. In various alternative aspects, the first female portion 664 may be the same as the female portion 586 of the mold 582 (FIG. 19).

With reference to FIG. 25, in another example, corrugated component precursors 580 are arranged in a mold 680 with the transverse component precursor 610 (or the transverse component precursor 630, not FIG. 21) disposed therebetween. Joining portions 681 of the transverse component precursor 610 are in direct contact with flange portion 592 of both corrugated component precursors 580 in joining regions 682.

Referring to FIG. 26, in yet another example, corrugated component precursors 580 are arranged in the mold 660. Mandrels 690 are disposed between wall portions 590 of the respective component precursors 580. The mandrels 690 may be made of a suitable material to withstand the temperatures and pressures of molding. For example, the mandrels 690 may include aluminum, steel, or other materials that will maintain their structural integrity at molding temperatures. The mandrels 690 may maintain spacing between the corrugated component precursors 580 during a subsequent joining operation.

With reference to FIG. 27, in yet another example, corrugated component precursors 580 and the transverse component precursor 610 (or the transverse component precursor 630, FIG. 21) are arranged in the mold 680. Mandrels 700 are disposed between wall portions 590 of the corrugated component precursor 580 and core portions 702 of the transverse component precursor 610 to maintain spacing between the component precursors 580, 610 during a subsequent joining operation.

### Joining Component Precursors

Returning to FIG. 18, at 548, component precursors are joined to form energy-absorbing assemblies. Joining the component precursors includes applying heat and pressure to the polymer resin. When the polymer resin is a thermoset polymer resin, joining causes additional cross-linking such that the thermoset polymer resin or polymer has a second DOC greater than the first DOC and less than or equal to 1. At the second DOC, the thermoset polymer resin or polymer is vitrified and is in a gelled glass state. DOC may be monitored based on output from the dielectric cure sensor 588 and/or average mold temperature, time in mold, and pressure. Joining causes the thermoplastic polymer resin in the corrugated component precursors 580 to cross-link across a boundary between the respective corrugated component precursors 580, thereby joining the component precursors 580 into a unitary structure that is substantially free of joints, seams, adhesive, or fasteners.

Although in the examples shown, all corrugated component precursors 580 are formed from the same polymer and have substantially the same DOC, in certain alternative aspects, corrugated component precursors different polymers and/or DOCS. DOCs of respective component precursors may be similar to improve processing and adhesion. For example, DOCs of first and second corrugated precursor components may be within 10% of one another, optionally within 5% of on another, optionally within 2% of one another, or optionally within 1% of one another.

When the polymer resin is a thermoplastic polymer resin, joining includes heating the thermoplastic polymer resin to a second temperature greater than or equal to the first temperature and less than the melting temperature. During joining, the component precursors 580 fuse together into a unitary structure that is free of joints, seams, adhesive, or fasteners. Although in all the examples shown, corrugated component precursors 580 are formed from the same polymer, they may alternatively be formed from different thermoplastic polymers.

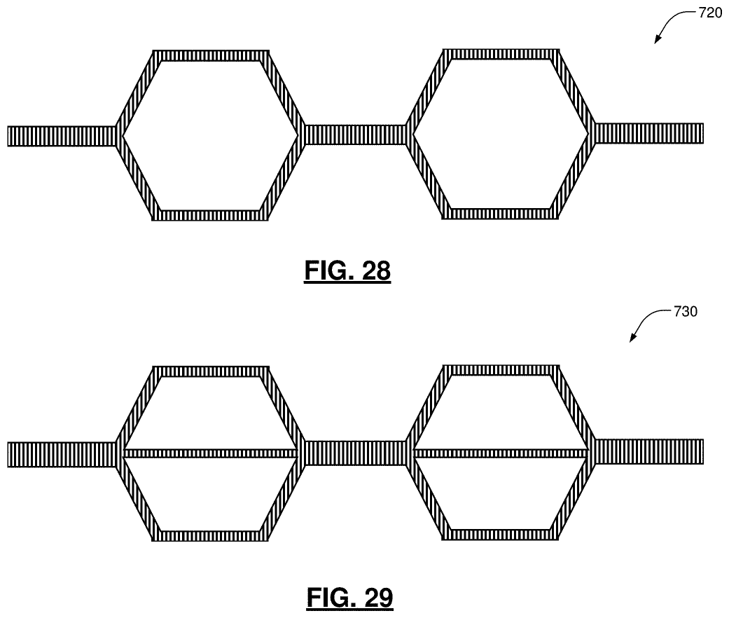

Returning to FIGS. 23-24 and 26, joining may include applying pressure in the joining regions 662. In the embodiment of FIGS. 23-24, pressure on the wall portions 590 may be minimized to reduce or prevent deformation of the wall portions 590. In the embodiment of FIG. 26, pressure may be applied uniformly across the corrugated component precursors 580 as the mandrels 690 maintain spacing. An energy-absorbing component 720 as shown in FIG. 28 may be formed. The energy-absorbing component 720 may be similar to the energy-absorbing component 12 of FIG. 3. The energy-absorbing component 720 may be a unitary structure that is substantially free of joints, seams, adhesive, or fasteners.

Returning to FIGS. 25 and 27, joining may include applying pressure in the joining regions 682. In the embodiment of FIG. 25, pressure on wall portions may be minimized to reduce or prevent deformation of the wall portions. In the embodiment of FIG. 27, pressure may be applied uniformly across the corrugated component precursors 580 as the mandrels 700 maintain spacing. An energy-absorbing component 730 may be similar to the energy-absorbing component 112 of FIG. 6. The energy-absorbing component 730 may be a unitary structure that is substantially free of joints, seams, adhesive, or fasteners.

### Post-Processing

Returning to FIG. 18, at 552, post-processing steps may optionally be performed. For example, weep openings (see, e.g., weep openings 496 of FIG. 16) may be machined into the energy-absorbing component 720 or 730 shown in FIG. 16.

### Forming Energy Absorbing Assembly

Returning to FIG. 18, at 556, the energy-absorbing component 720 or 730 may optionally be coupled to a housing, such as in any of the arrangements described above, to form an energy-absorbing assembly. Coupling may include the use of adhesive and/or mechanical fasteners. In certain aspects, the energy-absorbing assembly may be a vehicle component, such as an automotive rocker. However, the energy-absorbing assembly may alternatively be used at other locations on an automobile, or on other vehicles, such as watercraft, recreational vehicles, agricultural equipment, trucks, buses, trains, or aircraft. Furthermore, the energy-absorbing assembly and methods described herein can be used in non-automotive applications.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of manufacturing an energy-absorbing structure comprising:
molding a first portion precursor comprising a first thermoset resin by partially curing the first thermoset resin such that the first thermoset resin has a first degree of cure less than one and the first thermoset resin is in a gelled glass state, the first portion precursor including a pair of first flange portions and first wall portion disposed between the pair of first flange portions;
molding a second portion precursor comprising a second thermoset resin by partially curing the second thermoset resin such that the second thermoset resin has a second degree of cure less than one and the second thermoset resin is in the gelled glass state; the second portion precursor comprising a pair of second flange portions and a second wall portion disposed between pair of second flange portions; and
forming the energy-absorbing structure by,
arranging the first portion precursor and the second portion precursor in a mold such that the pair of first flanges portions is in contact with the pair of second flange portions in a respective pair of joining regions, and
joining the first portion precursor and the second portion precursor by applying heat and pressure to the pair of joining regions such that the first thermoset resin has a third degree of cure and the second thermoset resin has a fourth degree of cure, the third degree of cure being greater than the first degree of cure and the fourth degree of cure being greater than the second degree of cure, wherein the energy-absorbing structure includes a pair of flanges and a cell, the pair of flanges being disposed in the pair of joining regions, respectively, and the cell comprising a cell wall and an interior region at least partially defined by the cell wall, the cell wall comprising the first wall portion and the second wall portion.

2. The method of claim 1, wherein:
the arranging comprises directly contacting the pair of first flange portions with the pair of second flange portions in the respective joining regions; and
the joining further comprises cross-linking the first thermoset resin and the second thermoset resin in the joining regions.

3. The method of claim 1, wherein the forming further comprises placing a mandrel between the first wall portion and the second wall portion prior to the joining.

4. The method of claim 1, wherein:
the arranging further comprises placing a third portion precursor between the first portion precursor and the second portion precursor such that the third portion precursor is in direct contact with the pair of first flange portions and the pair of second flange portions in the respective joining regions, the third portion precursor comprising a third thermoset resin; and
the joining further comprises cross-linking the third thermoset resin with the first thermoset resin and the second thermoset resin in the respective joining regions.

5. The method of claim 4, further comprising molding the third portion precursor prior to the forming, the third portion precursor comprising a third thermoset resin, the molding comprising partially curing the third thermoset resin such that the third thermoset resin has a fifth degree of cure less than one, wherein the joining causes the third thermoset resin to have a sixth degree of cure greater than the fifth degree of cure.

6. The method of claim 4, wherein:
the third portion precursor comprises a third thermoset resin;
prior to the forming, the third portion precursor has a predetermined viscosity and a fifth degree of cure, the fifth degree of cure being about zero; and
the joining causes the third thermoset resin to have a sixth degree of cure greater than the fifth degree of cure.

7. The method of claim 4, wherein the third portion precursor comprises a plurality of reinforcing fibers, at least a portion of the plurality of reinforcing fibers being oriented substantially parallel to a thickness of the flange.

8. The method of claim 4, wherein the third portion precursor comprises an average roughness of greater than or equal to about 0.1 μm, a surface texture, a plurality of ribs, or any combination thereof.

9. The method of claim 4, wherein the flanges each have a width of greater than or equal to about 10 mm, the width being defined between the cell wall and a respective distal flange end.

10. The method of claim 1, wherein:
the molding the first portion precursor comprises determining that the first thermoset resin has the first degree of cure based on output from a first dielectric cure sensor;
the molding the second portion precursor comprises determining that the second thermoset resin has the second degree of cure based on output from a second dielectric cure sensor; and
the joining comprises determining that the first thermoset resin has the third degree of cure and the second thermoset resin has the fourth degree of cure based on output from a third dielectric cure sensor.

11. The method of claim 1, wherein:
the molding the first portion precursor comprises determining that the first thermoset resin has the first degree of cure based on a first average mold temperature;
the molding the second portion precursor comprises determining that the second thermoset resin has the second degree of cure based on a second average mold temperature; and
the joining comprises determining that the first thermoset resin has the third degree of cure and the second thermoset resin has the fourth degree of cure based on a third average mold temperature.

12. The method of claim 1, further comprising forming a weep opening in the cell wall.

13. An energy-absorbing structure comprising:
a first portion comprising a pair of first flange portions and a first wall portion disposed between the pair of first flange portions, the first portion comprising a first thermoset polymer;
a second portion comprising a second pair of flange portions and a second wall portion disposed between the second pair of flange portions, the second portion comprising a second thermoset polymer;
a cell comprising a cell wall and a first interior region at least partially defined by the cell wall, the cell wall comprising the first wall portion and the second wall portion;
a pair of flanges including the pair of first flange portions and the pair of second flange portions, respectively, wherein the first thermoset polymer is cross-linked with the second thermoset polymer at the pair of flanges.

14. The energy-absorbing structure of claim 13, wherein:
the cell extends along a cell axis between a first end having a first wall thickness and a first maximum dimension and a second end having a second wall thickness and a second maximum dimension;
the second end is configured to fail prior to the first end in response to an impact to the cell; and
(i) the second thickness is less than the first thickness, (ii) the second maximum dimension is less than the first maximum dimension, or (iii) the second thickness is less than the first thickness and the second maximum dimension is less than the first maximum dimension.

15. The energy-absorbing structure of claim 13, wherein:
the cell comprises a first cell and a second cell, the first cell having a first stiffness and extending along a first cell axis, and the second cell having a second stiffness greater than the first stiffness and extending along a second cell axis;
the first cell defines a first length substantially parallel to the first cell axis and a first maximum dimension substantially perpendicular to the first cell axis;
the second cell defines a second length substantially parallel to the second cell axis and a second maximum dimension substantially perpendicular to the second cell axis; and
(i) the second length is greater than the first length, (ii) the second maximum dimension is greater than the first maximum dimension, or (iii) the second length is greater than the first length and the second maximum dimension is greater than the first maximum dimension.

16. The energy-absorbing structure of claim 13, further comprising a housing comprising a housing wall and a second interior region, the energy-absorbing structure being disposed within the second interior region and coupled to the housing wall.

17. An energy-absorbing structure comprising:
a first portion comprising a first pair of flange portions and a first wall portion disposed between the first pair of flange portions, the first portion comprising a first thermoset polymer;
a second portion comprising a second pair of flange portions and a second wall portion disposed between the second pair of flange portions, the second portion comprising a second thermoset polymer;
a third portion comprising a third thermoset polymer;
a cell comprising a cell wall and a first interior region at least partially defined by the cell wall, the cell wall comprising the first wall portion and the second wall portion;
a pair of flanges comprising the first pair of flange portions and the second pair of flange portions, respectively, wherein the third thermoset polymer is cross-linked with the first thermoset polymer and the second thermoset polymer at the pair of flanges.

18. The energy-absorbing structure of claim 17, wherein:
the cell extends along a cell axis between a first end having a first wall thickness and a first maximum dimension and a second end having a second wall thickness and a second maximum dimension;
the second end is configured to fail prior to the first end in response to an impact to the cell; and
(i) the second thickness is less than the first thickness, (ii) the second maximum dimension is less than the first maximum dimension, or (iii) the second thickness is less than the first thickness and the second maximum dimension is less than the first maximum dimension.

19. The energy-absorbing structure of claim 17, wherein:
the cell comprises a first cell and a second cell, the first cell having a first stiffness and extending along a first cell axis, and the second cell having a second stiffness greater than the first stiffness and extending along a second cell axis;
the first cell defines a first length substantially parallel to the first cell axis and a first maximum dimension substantially perpendicular to the first cell axis;
the second cell defines a second length substantially parallel to the second cell axis and a second maximum dimension substantially perpendicular to the second cell axis; and
(i) the second length is greater than the first length, (ii) the second maximum dimension is greater than the first maximum dimension, or (iii) the second length is greater than the first length and the second maximum dimension is greater than the first maximum dimension.

20. The energy-absorbing structure of claim 17, further comprising a housing comprising a housing wall and a second interior region, the energy-absorbing structure being disposed within the second interior region and coupled to the housing wall.
